(19) United States
(12) Patent Application Publication
(10) Pub. No.: US 2015/0143820 A1
(43) Pub. Date: May 28, 2015

(54) CRYOSTAT

(71) Applicant: The Science and Tecnology Facilities Council, Didcot Oxfordshire (GB)

(72) Inventor: Oleg Kirichek, Didcot Oxfordshire (GB)

(73) Assignee: The Science and Technology Facilities Council, Didcot Oxfordshire (GB)

(21) Appl. No.: 14/404,772

(22) PCT Filed: May 28, 2013
(86) PCT No.: PCT/GB2013/051397

§ 371 Date: Dec. 1, 2014

(30) Foreign Application Priority Data
Jun. 1, 2012 (GB) 1209849.7

(51) Int. Cl. F17C 13/00; F25B 9/14

(52) U.S. Cl. CPC F17C 13/00; F25B 9/14
USPC 62/6

(57) ABSTRACT

A cryostat (10) is disclosed having a multistage cryocooler (20) with at least first and final cooling stages (22,32), and first and final stage heat exchangers (24,34) thermally coupled to the corresponding cooling stages for cooling a cryogen passing along a cooling path (15). The cooling path (15) further comprises a terminal cooling chamber (40) arranged to receive the cryogen from the final stage heat exchanger (34). The terminal cooling chamber (40) is also thermally coupled to the final cooling stage (32) so as to further cool the cryogen. The terminal cooling chamber (40) may include baffles (210) for directing the cryogen along an extended path through the terminal cooling chamber (40).

The present invention relates to a cryostat which includes a cryocooler arranged to cool a cryogen such as helium passing along a cryogen path. Some embodiments of the invention relate to cryostats in which the cryogen is recirculated along the cryogen path.

### INTRODUCTION

Cryostats are used to maintain low temperatures for a variety of different purposes such as to maintain low sample temperatures in neutron and X-ray scattering experiments, to minimise thermal noise by cooling photon detectors in research, industrial and military imaging, and so forth.

To attain temperatures within a few degrees of zero Kelvin, helium is used as a refrigerant, and modern cryostats frequently contain a cryocooler element to cool helium gas to sufficiently low temperatures to liquify the helium. Further cooling of a thermal load may then be carried out by evaporation of the liquid helium, for example. However, helium is an increasingly expensive commodity, so in recent years there has been an increasing focus on recirculating and recondensing the helium cryogen within the cryostat, rather than more simply releasing the evaporated helium into the atmosphere.

Recirculation and recondensation of helium within a cryostat is described, for example, in Chao Wang “Efficient helium recondensing using a 4 K pulse tube cryocooler”, Cryogenics 45 (2006) 719-724, and in C. R. Chapman et al., “Cryogen-free cryostat for neutron scattering sample environment”, Cryogenics 51 (2011) 146-149. Such cryostats typically make use of a cryocooler device to cool the cryogen to low temperatures, such as a Stirling engine, Gifford-McMahon or pulse tube refrigerator cryocooler. Such cryocoolers may consist of one, two or more cooling stages, typically to bring the cryogen down to a temperature of around 3-4 Kelvin. The cryostat may also include equipment to provide even lower temperatures, using effects such as adiabatic demagnetization and helium based dilution refrigeration.

Although heat transfer of only a few Watts may be needed in order to maintain very low temperatures in the cryostat, because of good thermal isolation properties of the cryostat including vacuum spaces, reflective surfaces and radiation baffles, the electrical power required to deliver this cooling power, for example by pumping a working fluid in the cryocooler, may amount to several kilowatts.

It would be desirable to address these and other issues of the related prior art.

### SUMMARY OF THE INVENTION

Accordingly, the invention provides a cryostat comprising: a multistage cryocooler having at least first and final cooling stages; and a cryogen path including first and final stage heat exchangers thermally coupled to the first and final cooling stages respectively for cooling a cryogen passing along the cryogen path, the cryogen cooling path further comprising a terminal cooling chamber arranged to receive the cryogen from the final stage heat exchanger and also being thermally coupled to the final cooling stage of the cryocooler so as to further cool the cryogen.

The cryogen may be helium, although other cryogens could be used depending for example on the required temperatures and pressures of operation of the cryostat. The cryogen path may be arranged such that the cryogen is recirculated around the path, for example using a pump.

The first and final stages of the cryocooler may be thermally coupled first and second stages, or may have one or more further stages between them. The cryocooler may be a multistage pulse tube refrigerator, but other cryocoolers such as multistage Stirling engine or Gifford-McMahon cryocooler could be used. Typically, each cooling stage of such a cryocooler may comprise a separate regenerator element.

The terminal cooling chamber may comprise a floor and one or more baffles which are arranged to direct the cryogen along one or more extended paths through the terminal cooling chamber. For example, the one or more baffles may be arranged to direct the cryogen along one or more labyrinthine paths through the terminal cooling chamber, and the cooling chamber may provide a plurality of routes for the cryogen to follow.

The one or more baffles comprise arcuate sections, for example according to a circular or ellipsoidal plan. In use, the floor of the terminal cooling chamber may be substantially horizontal, so that the cryogen can flow freely along the one or more paths.

The baffles may, for example, extend upwardly from the floor of the terminal cooling chamber and/or downwards into the chamber. The baffles may thereby define bounded pathways which restrict movement of the cryogen to being along the pathway, or may allow some overflow or movement of the cryogen laterally between adjacent pathways.

The cryostat may be designed such that the volume of the cryogen path within the terminal cooling chamber is greater than that within the final stage heat exchanger, for example at least 30% greater, or at least 50% greater. One effect of this may be that, in use, the average residence time of the cryogen in the terminal cooling chamber is greater than the residence time of the cryogen in the final stage heat exchanger. The cryostat may also be arranged such that, in use, the impedance of the terminal cooling chamber to the flow of the cryogen is significantly less than that of the final stage heat exchanger, for example less than half that of the final stage heat exchanger.

The cryostat may be arranged such that, in operation, at least some of the cryogen condenses in the terminal cooling chamber.

One or more of the baffles may be in contact with an underside of a cold end of the final cooling stage. One of more of the baffles may be integrally formed with the floor of the terminal cooling vessel, or with a ceiling of the terminal cooling vessel.

The terminal cooling chamber may be fixed to an underside of a cold end of the final cooling stage.

The final stage heat exchanger may be thermally coupled to the cold end of the final cooling stage and/or to a regenerator of the final cooling stage. If the final stage heat exchanger is thermally coupled to the cold end of the final cooling stage, then the cryogen path may further comprise a regenerator heat exchanger thermally coupled to the regenerator of the final cooling stage.

Either or each of the final stage heat exchanger, and if present the regenerator heat exchanger, may comprise a cryogen path tube coiled around the cold end of the final cooling stage or the regenerator respectively.

The cryogen path may further comprise a thermal load arranged to receive the cryogen from the terminal cooling chamber, and a pump arranged to drive the cryogen along the cryogen path. For example, the thermal load may include a cryogen expansion point and a further heat exchanger for receiving heat from an experiment sample or device such as an electronic device, or from a further thermal system coupled to such a sample or device.

The invention also provides corresponding methods, for example a method of operating a cryostat comprising: cooling a cryogen using sequential first and final stage heat exchangers thermally coupled to first and final cooling stages of a multistage cryocooler; subsequently further cooling the cryogen using a terminal cooling chamber which is also thermally coupled to the final cooling stage of the cryocooler; and delivering the further cooled cryogen to a thermal load.

In such methods, the cooling chamber may comprise a floor, which may be substantially horizontal, and may comprise one or more upright baffles which are arranged to direct the cryogen along one or more extended, labyrinthine paths through the terminal cooling chamber. The method may further comprise recirculating the cooled cryogen delivered to the thermal load back through the first and final stage heat exchangers and terminal cooling chamber for reuse.

### BRIEF DESCRIPTION OF THE DRAWINGS

Embodiments of the invention will now be described, by way of example only, with reference to the drawings of which:

FIG. 1 shows schematically a cryostat according to the invention including a two stage cryocooler for cooling a cryogen passing along a cryogen path for cooling a load;

FIG. 2 shows in cross section a more particular engineering example of the cryostat of FIG. 1;

FIG. 3 shows in perspective view a terminal cooling chamber for fixing to the underside of the cold end of the final cooling stage of the cryocooler of FIG. 1 or 2; and

FIGS. 4 and 5 show other structures for a terminal cooling chamber in plan view.

### DETAILED DESCRIPTION OF EMBODIMENTS

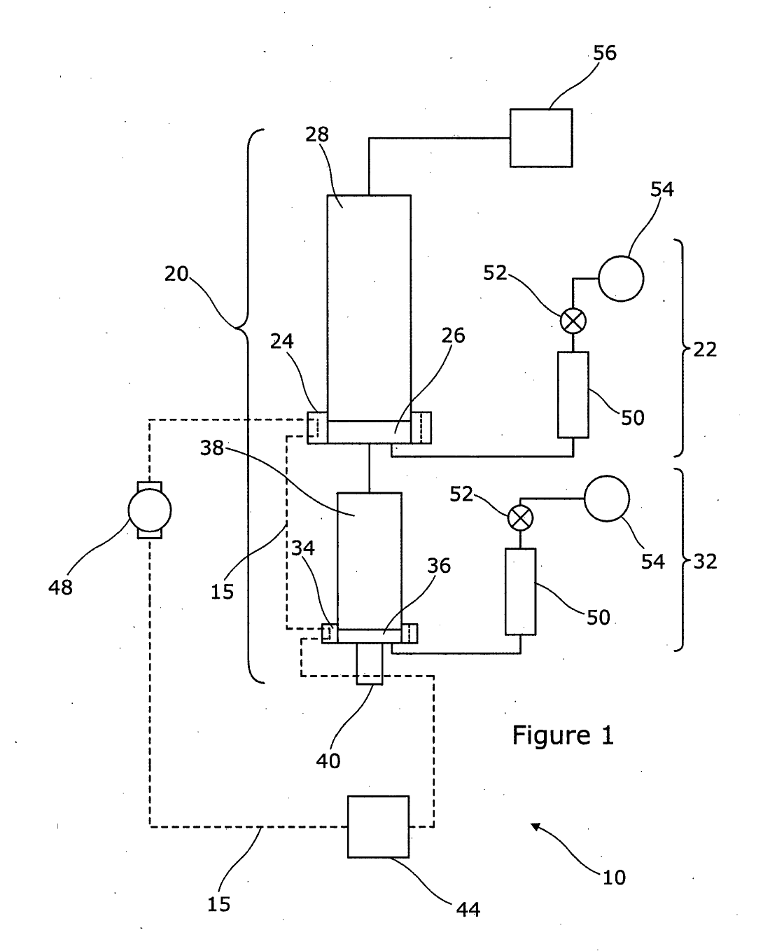

Referring now to FIG. 1 there is shown a cryostat 10. The cryostat may, for example, comprise some or all of the elements depicted in FIG. 1 enclosed within a dewar or other insulating vessel (not shown). A multistage cryocooler 20 includes at least a first cooling stage 22 and a final cooling stage 32. A cryogen path 15 along which a cryogen such as helium passes is depicted in the figure using a broken line. The cryogen path 15 includes at least a first stage heat exchanger 24 thermally coupled to a cold end 26 of the first cooling stage 22 and a final stage heat exchanger 34 thermally coupled to a cold end 36 of the final cooling stage 32.

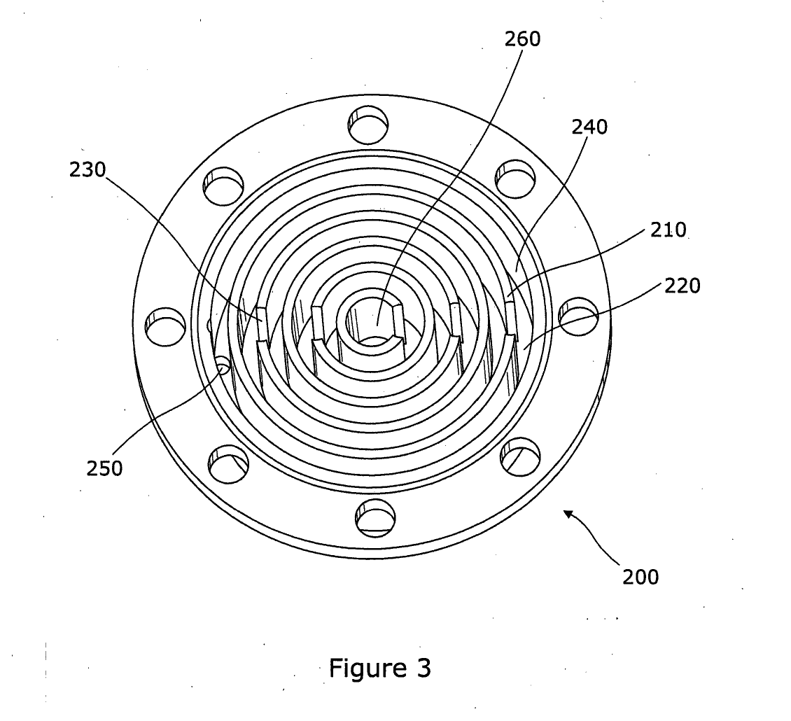

After passing through the first and final stage heat exchangers the cryogen path 15 carries the cryogen on to a terminal cooling chamber 40 which is also thermally coupled to the cold end 36 of the final cooling stage 32 for further cooling. Different ways in which the terminal cooling chamber 40 may be constructed are discussed in more detail below, for example with reference to FIG. 3.

After leaving the terminal cooling chamber 40 the cryogen is used to cool a thermal load 44, for example including by passing the cryogen through an expansion point to further lower the temperature of the cryogen. The thermal load 44 could include a further cooling mechanism such as a dilution refrigeration insert. A cryogen pump 48 may be used to drive the cryogen along the cryogen path. The cryogen path may be closed and the cryogen may thereby be recirculated. Alternatively, an open path may be used and fed, for example, from a cryogen source at elevated pressure such as a pressurised gas bottle.

The cryocooler 20 may be, for example, a multistage pulse tube cryocooler. To this end, the cryocooler of FIG. 1 shows a working fluid pump 56 arranged to deliver pressure pulses in a working fluid into a first stage regenerator 28 of the first cooling stage 22, and from the first stage regenerator 28 into a final stage regenerator 38 of the final cooling stage 32. Each of the first and final cooling stages then further includes working fluid connection from the respective cold end to a respective pulse tube 50, inertance 52 and reservoir 54.

Other arrangements and implementations of a multistage cryocooler may be used, for example including multiple cooling stages of one or more of pulse tube, Gifford-McMahon and/or Stirling engine types. Although FIG. 1 shows only first and final cooling stages, further cooling stages may be used with further heat exchangers at respective cold ends as required, and one or more further heat exchangers such as regenerator heat exchangers may be used.

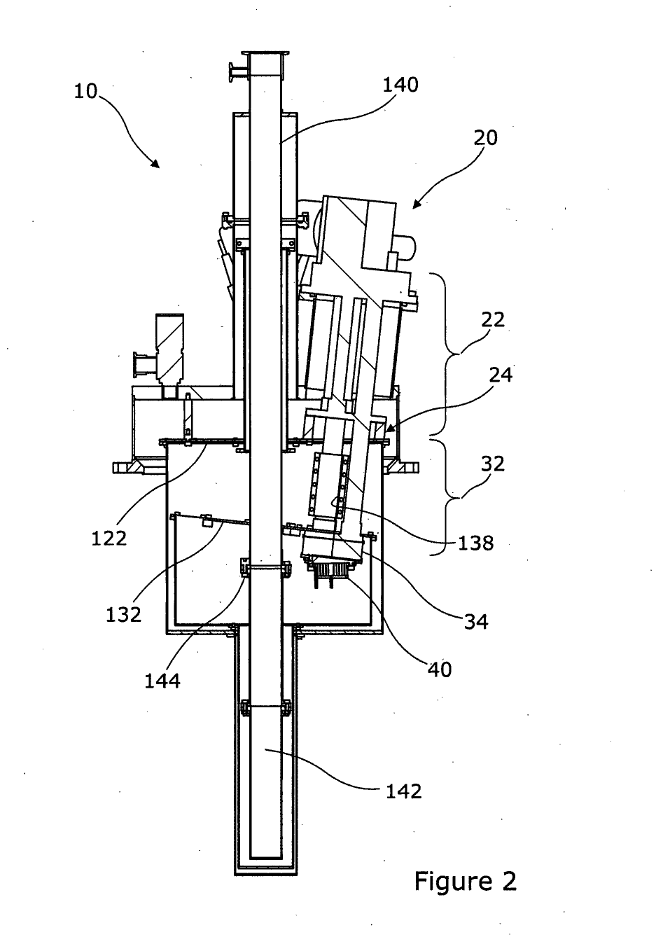

The cryostat of FIG. 1 may be used for a variety of purposes. FIG. 2 shows in cross section an implementation according to one such purpose, which provides a top loading cryostat arranged to present a sample at cryogenic temperatures to a neutron beam in a neutron scattering experiment. However, various aspects depicted in and described in respect of FIG. 2 may be used for other applications as appropriate. For clarity, elements corresponding to those of FIG. 1 are given corresponding reference numerals.

The cryostat of FIG. 2 includes a multistage pulse tube cryocooler 20 which may be, for example, a Cryomech PT410 cooler. The cooling power of this particular model is given as 1 Watt at 4.2 K with an electric input power to the compressor of 7.2 kW. A first stage radiation shield 122 and a second stage radiation shield 132 are mechanically connected to the first cooling stage 22 and second cooling stage 32 respectively of the cryocooler 20. The long variable temperature insert (VTI) tube 140 is thermally linked by copper braids to the flanges of the thermal shields 122, 132. In use, a sample stick (not shown) is loaded into the VTI tube 140 and carries a sample for location in an experiment region 142 of the VTI tube 140. The sample stick has a set of baffles to reduce infrared heat load on the sample from above.

The cryostat uses a cryogen passing along a cooling path for cooling the sample. The cryogen may typically be helium, and may be at elevated pressure for example at between 0.3 MPa and 1 MPa. This may be supplied continuously from a high pressure bottle via a liquid nitrogen cooled cold trap, or could be circulated in a continuous manner around the cooling path using a pump. For clarity, not all parts of the cryogen path are shown in FIG. 2.

The cryogen enters the first stage heat exchanger 24 which may consist of a copper tube, for example about 1.5 m long and 3 mm in internal diameter, hard soldered to a copper former which is thermally connected to the cold end of the first cooling stage 22. The temperature of the cryogen on entry to the first stage heat exchanger may be for example around 200 K, and on exit around 50 K.

After passing through the first stage heat exchanger 24 the cryogen enters a regenerator heat exchanger 138. This heat exchanger is designed to sit on the regenerator tube of the final cooling stage 32 of the cryocooler 20, and may be made for example from a tube silver soldered to a high purity copper jacket. The final stage regenerator heat exchanger may bring the temperature of the cryogen down to about 10 K.

After passing through the regenerator heat exchanger 138 the cryogen enters the final stage heat exchanger 34. This heat exchanger may consist for example of a copper tube about 3 m long and about 3 mm in internal diameter coiled and hard soldered around a copper former thermally connected to the cold end of the final cooling stage 32. On leaving the final stage heat exchanger the temperature of the cryogen may be typically about 5 K.

Typically, the cold end of the final cooling stage may be at about 3.8 K. In order to make better use of the cooling available from the final cooling stage, on leaving the final stage heat exchanger the cryogen enters a terminal cooling chamber 40. Depending on the particular temperature and pressure characteristics of the cryogen at this stage, and the temperature of the cold end 36 of the final cooling stage, the cryogen may condense or partially condense within the terminal cooling chamber. Aspects of the terminal cooling chamber 40 are discussed in more detail below. The structure and internal volume of the terminal cooling chamber may be arranged such that the residence time of the cryogen is longer in the terminal cooling chamber than in the final stage heat exchanger. The internal or working volume of the terminal cooling chamber may be larger than that of the final stage heat exchanger, for example about 4000 cubic millimetres. From the terminal cooling chamber 40 the cryogen is fed, typically now in liquid form although other fluid forms may be found here depending on temperature and pressure, to the thermal load, which in the arrangement of FIG. 2 is a VTI heat exchanger 144, through an impedance tube. This impedance tube may typically be a wire-in-tube impedance built for example using a 0.39 mm stainless steel wire supplied by Ormiston Wire Ltd of the UK and 0.4 mm internal diameter stainless steel tube supplied by Coopers Needle Works Ltd also of the UK. The length of the impedance tube may be optimised through repeated testing to achieve the best compromise between minimum VTI temperature and maximum cooling power.

In the VTI heat exchanger the cryogen passes through an expansion point, leading to evaporation and therefore a further reduction in temperature, and the resulting helium vapour may then be extracted and released to the environment, or recirculated within the cryogen path, by means of a vacuum pump (not shown) such as an Edwards XDS 35i dry scroll pump. The pumping line from the VTI heat exchanger 144 is thermally linked to the first and second stage radiation shields 122, 132, in order to recover further cooling power from the evacuated cryogen and to intercept ambient heat loads during initial system cool down. The pumping line contains a set of baffles positioned to coincide with the thermal shield flange locations in order to increase the heat exchange efficiency at these points.

Thermal contact between the VTI heat exchanger 144 and the sample in sample region 142 of the VTI tube 140 is achieved using a cold exchange gas. A temperature range at the sample from about 1.35 K to about 300K can be achieved by the appropriate use of exchange gas and sample heating. This range can also be extended to lower temperatures by using a dilution refrigerator insert in the VTI tube 140. One of the main advantages of using a VTI tube 140 arranged as shown in FIG. 2 is the absence of liquid helium in the horizontal plane of the sample which makes it ideal for neutron or X-ray scattering experiments, with which liquid helium can interfere.

The terminal cooling chamber 40 of FIG. 1 or 2 is arranged to provide an extended residence time and relatively unconstrained flow regime for the cryogen relative to the coiled tube structures typically used for the first and second stage heat exchangers. For example, the impedance to cryogen flow of the terminal cooling chamber may be lower, for example less than half and more preferably less than 10% of that of the final stage heat exchanger. Similarly, the volume of the terminal cooling chamber may be significantly bigger than that of the final stage heat exchanger, for example at least 50% greater.

To this end, the terminal cooling chamber may be constructed to comprise a floor and one or more baffles which are arranged to direct the cryogen along one or more extended, labyrinthine paths through the terminal cooling chamber. To facilitate the cryogen flow and reduce pooling and stagnation points especially of condensed cryogen, the floor of the terminal cooling chamber may be substantially horizontal, or a floor sloping from entrance to exit of the cryogen, for example using a conical form, could be used.

FIG. 3 depicts a terminal cooling chamber component 200 found suitable for use with the arrangements of FIGS. 1 and 2. The chamber component of FIG. 3 is constructed as a unitary component, integrally formed of high purity oxygen reduced copper milled from a single copper piece, although other construction techniques and materials could be used. A plurality of baffles 210 extend upwardly from a floor 220 of the component. In the arrangement of FIG. 3 each baffle 210 is circular or cylindrical, with a single gap 230 in each circle to permit flow of the cryogen from one side of the baffle 210 to the other (for example from the inside to the outside or vice versa). The circular baffles 210 are substantially concentric with respect to each other and the cylindrical boundary wall 240 of the chamber, with the gaps 230 arranged to be on opposing sides of concentrically adjacent baffles 210, so that cryogen flowing through the chamber is presented with a labyrinthine route or path.

The cryogen may be introduced into the terminal cooling chamber through a peripheral hole 250 at the edge of the floor 220, and extracted through a central hole 260 in the floor (not visible in FIG. 3) or vice versa.

The terminal cooling chamber component of FIG. 3 comprises a flange 270 extending from an upper edge of the boundary wall 240, with which the component 200 can be bolted or otherwise secured to an underside of the cold end 36 of the final cooling stage of the cryocooler 20. The top edges of the baffles 210 may then make contact with an underside surface of the cold end 36 in order to constrain the cryogen to flow between and not over the baffles.

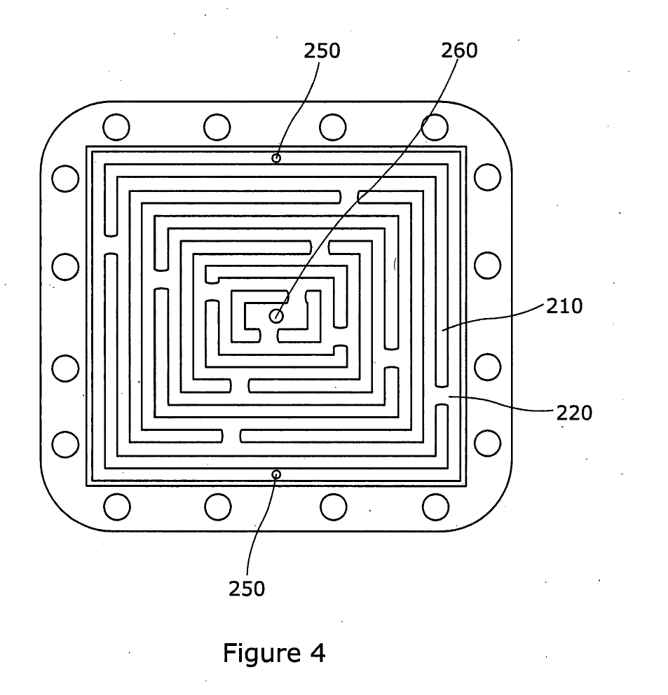

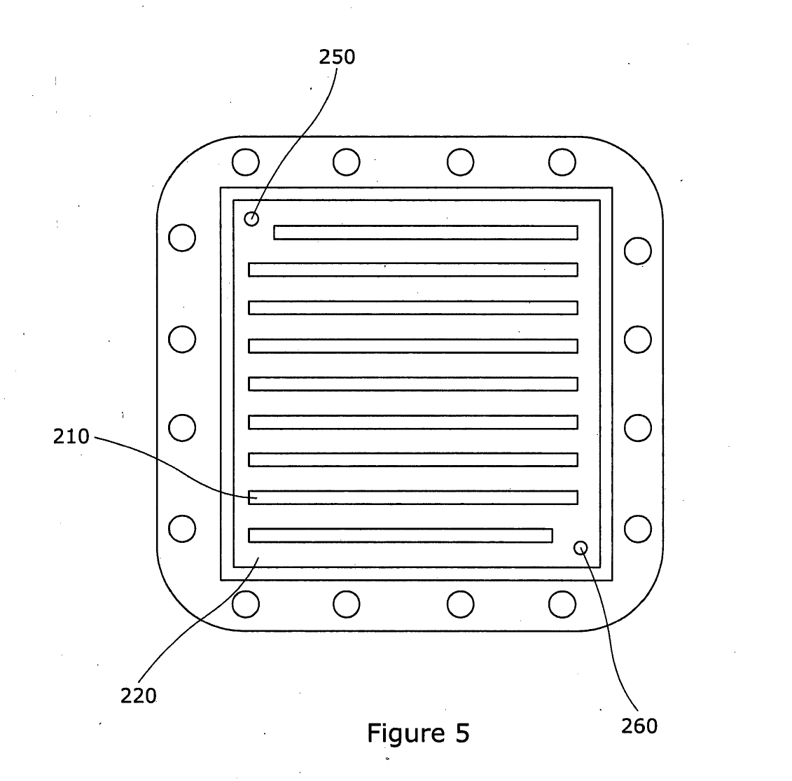

In some alternative constructions, the terminal cooling chamber 40 may be provided with baffles which extend downwards and/are formed integrally with a ceiling of the terminal cooling chamber. Other flange configurations could be used, for example providing single or multiple spiral paths between single or multiple entry and exit holes, which may be located in a floor, wall or ceiling of the terminal cooling chamber, at peripheral, central and/or intermediate points. Although the chamber component depicted in FIG. 3 is substantially circular, and this shape is likely to suit many applications, other shapes could be used such as the rectangular forms used in the chamber components depicted in plan view in FIGS. 4 and 5. in which the same reference numerals as used in FIG. 3 have been used for similar elements.

Although particular embodiments of the invention have been described, a number of modifications and variations will be apparent to the skilled person. For example, although a cryostat using a multistage cryocooler has been described, the invention could also be implemented with a single stage cryocooler, wherein the final cooling stage described herein is the single stage of the cryocooler.

1. A cryostat comprising:
a multistage cryocooler having at least first and final cooling stages; and
a cryogen path including first and final stage heat exchangers thermally coupled to the first and final cooling stages respectively for cooling a cryogen passing along the cryogen path,
the cryogen cooling path further comprising a terminal cooling chamber arranged to receive the cryogen from the final stage heat exchanger and also being thermally coupled to the final cooling stage of the cryocooler so as to further cool the cryogen.

2. The cryostat of claim 1 wherein the terminal cooling chamber comprises a floor and one or more baffles which are arranged to direct the cryogen along one or more extended paths through the terminal cooling chamber.

3. The cryostat of claim 2 wherein the one or more baffles are arranged to direct the cryogen along one or more labyrinthine paths through the terminal cooling chamber.

4. The cryostat of claim 2 wherein the one or more baffles comprise arcuate sections.

5. The cryostat of claim 2 arranged such that, in use, the floor of the terminal cooling chamber is substantially horizontal.

6. The cryostat of claim 2 wherein the baffles extend upwardly from the floor.

7. The cryostat of claim 1 arranged such that, in use, the impedance of the terminal cooling chamber to the flow of the cryogen is less than half that of the final stage heat exchanger.

8. The cryostat of claim 1 arranged such that the internal volume of the terminal cooling chamber is at least 50% greater than that of the final stage heat exchanger.

9. The cryostat of claim 1 arranged such that, in operation, at least some of the cryogen condenses in the terminal cooling chamber.

10. The cryostat of claim 2 wherein the one or more baffles are in contact with an underside of a cold end of the final cooling stage.

11. The cryostat of claim 1 wherein the terminal cooling chamber is fixed to an underside of a cold end of the final cooling stage.

12. The cryostat of claim 11 wherein the final stage heat exchanger is thermally coupled to the cold end of the final cooling stage.

13. The cryostat of claim 11 wherein the final stage heat exchanger is thermally coupled to a regenerator of the final cooling stage.

14. The cryostat of claim 12 wherein the final stage heat exchanger comprises a cryogen path tube coiled around the cold end of the final cooling stage or the regenerator respectively.

15. The cryostat of claim 1 wherein each of at least the first and final cooling stages of the multistage cryocooler comprises a separate regenerator.

16. The cryostat of claim 1 wherein the multistage cryocooler is a multistage pulse tube cryocooler, and the first and final cooling stages comprise separate regenerators of the multistage pulse tube cryocooler.

17. The cryostat of claim 1 wherein the cryogen path further comprises a thermal load arranged to receive the cryogen from the terminal cooling chamber, and a pump arranged to drive the cryogen along the cryogen path.

18. The cryostat of claim 1 wherein the cryogen path is arranged for the cryogen to recirculate around the path.

19. The cryostat of claim 1 comprising said cryogen, wherein the cryogen is helium.

20. A method of operating a cryostat comprising:
cooling a cryogen using sequential first and final stage heat exchangers thermally coupled to first and final cooling stages of a multistage cryocooler respectively;
subsequently further cooling the cryogen using a terminal cooling chamber which is also thermally coupled to the final cooling stage of the cryocooler; and
delivering the further cooled cryogen to a thermal load.

21. The method of claim 20 wherein the cooling chamber comprises one or more baffles which are arranged to direct the cryogen along one or more extended, labyrinthine paths through the terminal cooling chamber, and the method further comprises recirculating the cooled cryogen delivered to the thermal load back through the first and final stage heat exchangers and terminal cooling chamber.

22. The method of claim 20 wherein the multistage cryocooler is a multistage pulse tube cryocooler.
